(19) United States
(12) Patent Application Publication
(10) Pub. No.: US 2006/0020086 A1
(43) Pub. Date: Jan. 26, 2006

(54) Ionomer modified polypropylene compound for superior scratch performance,low blushing and molded in color with controllable gloss

(76) Inventor: Dennis Smith, Akron, OH (US)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(21) Appl. No.: 10/528,903

(22) PCT Filed: Sep. 19, 2003
(86) PCT No.: PCT/US03/29295

§ 371 Date: Mar. 18, 2005

Related U.S. Application Data
(60) Provisional application No. 60/412,054, filed on Sep. 19, 2002.

(51) Int. Cl. C08L 23/00

(52) U.S. Cl. 525/240

(57) ABSTRACT

The invention pertains to a polyolefin blend, which imparts superior physical properties, which may include enhanced scratch resistance, toughness and low temperature performance, and higher flexural modulus and rigidity. The blends in this invention impart improved performance and processability over existing products.

### OBJECTS OF THE INVENTION

The development of a compound comprised of a polypropylene, an impact modifier functionalized and/or crosslinked, and/or ionomer wax or functionalized monomer, and an ethylene-based polyolefin-metal salt. The polypropylene may be homopolymer, a copolymer of propylene and ethylene, and an oxy-propylene or a blend thereof. The impact modifiers and functionalized modifiers may include a copolymer of ethylene and an alpha-olefin modified with maleic anhydride; a styrenic copolymer or elastomer with maleic anhydride grafting; ethylene vinyl acetate modified with maleic anhydride or hydroxyl ethyl acrylate; terpolymers or copolymers of ethylene, butyl acrylate, and or glycidyl methacrylate; terpolymers of ethylene, ethyl, methyl or butyl acrylate, and or maleic anhydride. The ionomer portion may be a copolymer or terpolymer modified with acrylate. The methods to produce such blends, as well as, the properties of said blends will be discussed. It will be shown that said blends have certain advantages over other prior arts.

### SUMMARY OF THE INVENTION

What we therefore believe to be comprised by our invention may be summarized inter alia in the following words:

A polyolefin blend comprising a propylene containing polymer,

an ethylene copolymer elastomer, which is a reaction product of a copolymer of ethylene and at least one alpha-olefin, this elastomer functionalized with maleic anhydride,

wherein the alpha-olefin is selected from 1-octene, 1-hexene, 1-heptene, 1-butene, 4-methyl-1-pentene, and mixtures thereof, and

an ethylene-based polyolefin-metal salt which is the product of an ethylene acid copolymer and a metal salt, the polyolefin-metal salt being an ionomer, an alpha, beta ethylenically unsaturated carboxylic acid polymer in which the acid units are neutralized with metal ion (s).

The polyolefin blend wherein the propylene polymer may be at least one of a homopolymer propylene or a random or block copolymer of propylene and ethylene, and the polyolefin blend maybe from about 10 to 80 weight percent of the propylene polymer, from about 1 to 50 weight percent of the ethylene copolymer, and from about 5 to 60 weight percent of the polyolefin-metal salt.

The polyolefin blend wherein the propylene polymer, for optimal hardness and scratch resistance, consists essentially of from 40 to 75 weight percent of the propylene polymer; from about 1 to 25 weight percent of the ethylene copolymer; and from 5 to 35 weight percent of the polyolefin-metal salt of the blend.

The polyolefin blend wherein the ethylene copolymer is crosslinked with peroxide or silane with a catalyst selected from the transition metals of Group VIII, including complexes of these metals, this material optionally crosslinked prior to compounding or in situ.

The polyolefin blend wherein the ethylene copolymer is a crosslinked/partially vulcanized thermoplastic elastomer.

The polyolefin blend wherein the propylene polymer is selected from at least one of a homopolymer propylene, a random or block copolymer of propylene, and ethylene, and the polyolefin blend may be from about 5 to 75 weight percent of the propylene polymer, from about 1 to 50 weight percent of the ethylene copolymer, and from about 5 to 65 weight percent of the polyolefin-metal salt.

The polyolefin blend which includes an interfacial impact modifier selected from a styrene-ethylene interpolymer, styrenic block copolymer or elastomer, and a random styrenic copolymer or elastomer, all of which may have been modified with maleic anhydride.

The polyolefin blend wherein the styrenic copolymers, interpolymers or elastomers modified with maleic anhydride represent between 1 to about 30 weight percent of the blend.

The polyolefin blend further comprising an ethylene vinyl acetate (EVA) with a vinyl acetate level between 5 to 80 weight percent with maleic anhydride or hydroxy ethyl acrylate.

The polyolefin blend wherein the functionalized ethylene vinyl acetate represents between 1 to 30 weight percent of the blend.

The polyolefin blend further comprising one or more of terpolymers or copolymers of ethylene, butyl acrylate, and glycidyl methacrylate (GMA); terpolymers of ethylene, ethyl, methyl or butyl acrylate, and maleic anhydride (MAH); terpolymers of ethylene, acrylic ester and maleic anhyrdride.

The polyolefin blend wherein the MAH (unsaturated anhydride) and acrylate (GMA) may be physically crosslinked prior to addition to blend or in situ.

The polyolefin blend wherein the modified acrylate copolymers or terpolymers may react with the free acid of the ionomer component.

The polyolefin blend wherein the modified acrylate copolymer or terpolymers represent between 1 to 30 weight percent.

The polyolefin blend wherein the polyolefin-metal salt is a copolymer or terpolymer ionomer, which is partially neutralized with a metal salt from 5 to 95%.

The polyolefin blend wherein the terpolymer ionomer is modified with methyl, butyl, or ethyl acrylate; wherein the acrylate content from 1 to 25 weight percent.

The polylefin blend wherein the acrylate content represents between 10 and 25 weight percent.

The polyolefin blend wherein the metal ion is selected from the group consisting of lithium, sodium, potassium, magnesium, calcium, barium, lead, tin, zinc, aluminum, cadmium, and mixtures thereof.

The polyolefin blend wherein the ethylene copolymer may include a low molecular weight ionomer wax or functionalized monomer representing from about 1 to 20 weight percent.

The polyolefin blend further comprising a filler from about 1 to 40 weight percent.

The polyolefin blend wherein the mineral filler is selected from talc, calcium carbonate, wollastonite, calcium sulfate, barium sulfate, metal fibers, nanocomposites, ceramic fibers and powders, polymeric fibers, crosslinked polymers, mica, silica, carbon fibers, metal fibers, clay, glass fibers, glass spheres, conductive fillers such as polyaniline, and sulfonated materials such as AMPS.

The polyolefin blend further comprising a surface and mold release agent such as high molecular weight silicone and silicone masterbatches, fatty acids (i.e. olyel palmitamide, erucamide and behanamide) representing from about 0.1 to 10 weight percent.

A process for preparing an article from a polyolefin blend consisting essentially of:

providing a propylene polymer containing polymer,

adding a compound which may act as an impact modifier or interfacial agent selected from at least one of: ionomer waxes or functionalized monomers; impact modifiers and functionalized modifiers; a styrenic copolymer or elastomer with maleic anhydride grafting; ethylene vinyl acetate modified with maleic anhydride or hydroxyl ethyl acrylate; terpolymers or copolymers selected from one or more of ethylene, butyl acrylate, and glycidyl methacrylate; terpolymers of ethylene, ethyl, methyl or butyl acrylate, and maleic anhydride; ethylene-propylene rubber with maleic anhydride grafting, the ionomer portion may be a copolymer or terpolymer modified with acrylate;

adding an ethylene based polyolefin-metal salt that is a reaction product of an ethylene containing polymer and a second organic monomer containing a hydrophilic moiety; such component being at least partially neutralized with a metal salt between 5 to 95%;

mixing the ethylene copolymer until partially or completely crosslinked and adding to the blend; or

crosslinking in situ while adding the propylene polymer and polyolefin-metal salt; or

mixing the propylene polymer, ethylene copolymer, and polyolefin-metal salt; and

injection molding, blow molding or extruding the blend into an article which will display high scratch resistance, low blushing upon impact, low temperature requirements when mandated, tape adhesion, molded in color, controlled gloss levels, superior weatherability, and sonic welding capabilities.

### FIELD OF INVENTION

### BACKGROUND OF THE INVENTION

Many have sought to develop an ionomer modified polypropylene compound with a complimentary blend of scratch resistance, processability, compatibility, toughness, ductility, and rigidity. These performance criteria are particularly important within the automotive industry. With the advent of modified polypropylene blends with metallocene type polymers and other rubbers, researchers have attempted to produce compounds with such performance characteristics, but failed. As may be readily recognized, polypropylenes are appropriate for applications which require high flexural modulus, must be environmentally friendly and weatherable, as well as possessing recyclability, and processability. Moreover, higher crystalline, homopolymer polypropylenes may exhibit good scratch and mar resistance, but lack the impact toughness and in some cases low temperature properties mandated by the respective automotive application.

Compounding the issue is the necessity to control gloss and perform against parts that are traditionally painted and in some cases have low temperature ductility. The addition of a rubber phase with a controlled domain size will impart a lower gloss surface. These controlled rubber phases will impact the surface morphology desired. The rubber portion will provide, in most cases, some low temperature ducility and even aid in tape adhesion to body side moldings. However, these modified blends lack the necessary scratch resistance of pure polypropylene compounds.

As the crystallinity of polypropylene increases, the surface hardness increases. With the addition of mineral filler, the surface hardness appears to only improve nominally. Moreover, the physical blend appears to deteriorate in terms of impact resistance, notch sensitivity, and whitening around scratches and point of impact. The morphology of the filler, the aspect ratio, as well as, the surface treatment seem to contribute to stress whitening. Importantly, if the fillers do not uniformly ‘wet-out’ or begin to ‘debond,’ the area around the particulate surface becomes exposed and thus contributes to the stress whitening of the compound.

The chemistry of the ionomer, as well as, the thermally reversible crosslinking within this thermoplastic contribute significantly to the mar resistance, a controllable gloss level, and some of the novel impact modification not associated with traditional PP and TPO blends. Ionomers, which are traditionally, known for their clarity and high gloss, can be readily modified control the gloss. Moreover, when incorporated in PP blends, ionomers will not dramatically deteriorate the overall cycle times and or mandate tooling changes.

In U.S. Pat. No. 6,403,721, it is suggested that the compatibility between polyolefins, especially polypropylene, with ionomers of ethylene and/or ethylene based polyolefin-metal salts, is greatly enhanced by the presence of polypropylene based polyolefin-metal salts. It is suggested that the physical polymers of these heterogeneous blends are controlled by the interfacial interactions between the constituent phases. With the presence of the propylene based polyolefin-metal salt, the dispersion is improved and there is superior reinforcement. The ionic bonding between the propylene-based polyolefin-metal salts in a propylene and the ethylene-based polyolefin-metal salts contributes to the improved scratch resistance, stiffness, and impact resistance.

Blends completed with a polypropylene polymer, propylene based polyolefin-metal salt in propylene and an ionomer did not show sufficient impact resistance at low temperatures, specifically −15 to −30 deg C. Using a multiaxial test, a critical test utilized by the automotive industry almost exclusively, these blends showed some brittle deformation even at room temperature. The functionality in these propylene-based polyolefin metal salts is roughly 1 wt. %, moreover, the propylene is traditionally homopolymer. This does not provide sufficient interfacial interaction between the propylene and ionomer; with this said, the ionomer portion will not adequately perform as an impact modifier.

### DETAILED DESCRIPTION OF THE INVENTION

The present invention offers a polyolefin blend that will deliver low temperature impact performance, superior scratch resistance, good elongation, high flexural modulus and rigidity, while meeting the high temperature cycling requirements and processability.

This invention relates to the blends of a polypropylene (homopolymer or copolymer of propylene and ethylene), a functionalized and or crosslinked rubber/elastomer, and a partially neutralized ionomer (5 to 95%). The term ionomer refers to a thermoplastic copolymer containing between 80-91 weight percent of alpha-olefin units and about 7-20 weight percent of alpha, beta ethylenically unsaturated carboxylic acid units said carboxylic acid units being about 5 to 95 percent neutralized. Optimal neutralization above 60 percent.

The level of the acid, the molecular weight, the percent neutralization, and the type of metal ion utilized will dictate the performance of the product, as well as, the compatibility. A higher acid and higher neutralized ionomer is essential for superior scratch resistance. The addition of a random copolymer of ethylene with ethylenically unsaturated carboxylic acid (acid copolymers) will not impart compatibility or scratch resistance. Moreover, these higher flow acid copolymers will impart surface tackiness and poor processability.

With the optional addition of a crosslinked portion, the compatibility between the ionomer phase and the polypropylene phase appears to be improved. This was particularly noted with the addition of a peroxide to the rubber phase (i.e. ethylene and alpha-olefin copolymer; ethylene and alpha-olefin copolymers with unsaturated anhydride such as maleic anhydride.) This was seen both when completed in-situ and with the rubber phase crosslinked prior to addition to the ionomer and polypropylene.

Interestingly, work was completed using hydrosilylation of carbonyl containing rubbers such as ethylene vinyl acetate with maleic anhydride, ethylene acrylate copolymers, and ethylene-polyolefin-metal salts (ionomers), and ethylene-polyolefin-metal salts with acrylate (ionomers.) Hydrosilylation crosslinking with platinum containing catalysts offer other methods to crosslink the available carbonyl bonds rather than the traditional carbon-carbon double bonds of unsaturated, sterically unhindered rubbers/elastomers. This crosslinked rubber phase in combination with the ionomer and polypropylene offer some unique appearances, soft touch requirements, and physical properties without deteriorating the scratch and mar resistance, heat cycle requirements of polypropylene, and or the low temperature impact performance.

In each of the aforementioned formulations, it may be advantageous to include one or more copolymers or interpolymers of styrene with grafted maleic anhydride; a reaction product of ethylene vinyl acetate with maleic anhydride or hydroxyl ethyl acrylate; a copolymer or terpolymer of ethylene, acrylate (glycidal methyl, methyl, butyl, or ethyl acrylate), acrylic ester and or maleic anhydride; ethylene-propylene rubber with maleic anhydride; a low molecular weight ionomer wax or functionalized monomer.

In the above mentioned blend, there is the advantageous option to include: Styrenic block or random copolymers and or elastomers with maleic anhydride grafting; ethylene and alpha-olefin copolymers/elastomers, potentially functionalized with maleic anhydride; ethylene vinyl acetate with maleic anhydride or hydroxyl ethyl acrylate; acrylate copolymers or terpolymers; terpolymers of ethylene, an alpha-olefin, and a diene; and an ethylene propylene rubber with maleic anhydride grafting.

The copolymers of ethylene and alpha, beta ethylenically unsaturated carboxylic acid can be neutralized in situ with a metal salt or base. Examples of this would be sodium hydroxide or zinc acetate dihydrate. The percent neutralization would be a function of the molecular weight of the starting acid copolymer, percent acid (number of carboxylic acid units), and the weight percent of the metal ion. For the best scratch and mar resistance, the optimal level of neutralization would be above 30%, preferably above 60% with a starting acid content above 5 wt %. Examples of the suitable cations include, lithium, sodium, potassium, magnesium, calcium, cadmium, barium, lead, tin, zinc, aluminum or a combination thereof.

With sufficient vacuum and removal of volatiles such as acetic acid and water from the neutralization, this reaction can be completed in situ while crosslinking the rubber phase. The addition sequence of the ingredients on an extruder is critical to the success of the blend.

The polyolefinic ionomer copolymer or terpolymer may include a P/X/Y composition where: P is the olefinic comonomer; X is an acrylate comonomer, such as butyl, methyl or ethyl acrylate; and Y is the functional comonomer, acrylic and or methacrylic acid.

Ethylene ionomers may include the follow options, but are not exclusively limited to: ethylene/acrylic acid; ethylene/methacrylic acid; ethylene/acrylic acid/n-butyl acrylate, ethylene/methacrylic acid/iso-butyl acrylate; ethylene/acrylic acid/iso-butyl acrylate; ethylene/methacrylic acid/n-butyl methacrylate; ethylene/acrylic acid/methyl methacrylate; ethylene/acrylic acid/methyl acrylate; ethylene/methacrylic acid/methyl acrylate; ethylene/acrylic acid/b-butyl methacrylate; and combinations of such blends modified with one or more metal salts.

Ionomer resins fall under the traditional trademarks of Iotek™ from Exxon Mobil; and Surlyn™ by E.I. Dupont de Nemours Co. The acid copolymers would again come from Dow, Exxon Mobil, or Dupont. The low molecular weight ionomer waxes from Honeywell under the tradename Aclyn™.

The work completed within this invention, in contrast to the prior art, demonstrates that the compatibilization between the ionomer phase and the propylene type polymer is dramatically improved with the incorporation of a functionalized and or crosslinked rubber/elastomer. For instance, the blends completed with the styrenic type block copolymers/elastomers when not functionalized with a hydrophilic moiety, ionomers, and polypropylene type polymers were dismissed. There was insufficient performance with regard to low temperature ductility, notch sensitivity, and low blushing. These materials appeared to significantly improve with the addition of maleic anhydride. Additionally, the performance of the styrenic block copolymer/elastomer materials was not superior to other impact and interfacial modifiers when weighed against the cost criteria in a TPO and pure polypropylene application.

The copolymers of ethylene and unsaturated alpha-olefin, the acrylate copolymers and terpolymers, as well as, the terpolymers of ethylene, and alpha-olefin and a diene may be crosslinked with peroxides or silanes prior to compounding with other constituent ingredients or in-situ. While the crosslinking agents assist with controlling the morphology of the blend and control the gloss level, it appears the peroxy groups may contribute to some of the compatibility between the rubber phase, ionomer phase, and polypropylene domains. When completed in one step, the compatibility appears to improve within the respective blend. The peroxide will partially crosslink the ionomer phase, and contribute to some of the toughness and unique processability of this compound. Ionomers have thermally reversible, ionic crosslinking and notably have superior recovery after deformation. This recovery after deformation provides the notable scratch and mar performance of these blends.

Styrene block copolymers are available from Shell Chemicals under the Tradename, Kraton (inclusive of Kraton G™, Kraton FG 1901X™, Kraton FG 1924X™,) Dexco Polymers with the Tradename Vector, and Septon grades of SEP, SEPS, SEBS, SEEBS or Hybrar™ grades 5127, 5125, 7125 (Division of Kuraray.)

The invention further includes the option to incorporate acrylate type copolymers and terpolymers such as, but not limited to: ethylene/ethyl acrylate/maleic anhydride; ethylene/methyl acrylate/maleic anhydride; ethylene/acrylic ester/maleic anhydride; ethylene/butyl acrylate/maleic anhydride; glycidal/methacrylate/anhydride.

This portion may be added on its own or crosslinked with peroxide or silane with a platinum catalyst. The silane and platininum catalyst may crosslink the carbonyl portion of the polymer.

These acrylate type polymers are sold under the tradename of Lotader™ from Atofina Chemicals.

The invention further includes the option to include terpolymers and copolymer toughening agents such: as propylene, alpha-olefin and a diene, with or without maleic anhydride grafting; ethylene propylene rubber with maleic anhydride grafting and ethylene/alpha-olefin elastomers with maleic anhydride funtionality. These polymers may be utilized as is or crosslinked prior to use or in situ. Additionally, these compounds may be partially vulcanized thermoplastic elastomers. Suitable polymers are trademarked as: Vistalon™ from Exxon Mobil; Royalene™ from Crompton (Uniroyal Chemicals, a division of Crompton.); Nordel™ from DuPont Dow Elastomers; Santoprene™ from Advanced Elastomer Systems/Exxon Mobil; Fusabond MN 493 or Fusabond MN 416 from E.I. Dupont de Nemours Co Dupont.

The polyolefin blend in this invention may utilize the following peroxides, but are not exclusively limited to: dialkyl peroxides such as- dicumyl peroxide; a,a′ Di(t-butylperoxy)-diisopropylbenzene; 2,5-dimethyl-2,5-Di-(t-butyl-peroxy) hexane; 2,5-dimethyl-2,5-Di-(t-butyl-peroxy)hexyne-3; peroxy-ketal such as -n-butyl 4,4-Di(t-butylperoxy)valerate; 1,1bis-(t-butylperoxy-)3,3,5-trimethyl-cyclohexane; diacyl such as: Dibenzoyl peroxide; peroxy-ester such as: t-butyl perbenzoate.

The polyolefin blend in this invention may utilize silane and platinum catalysts.

This polyolefin blend contains stabilizers and chemical modifiers, which will improve the long term performance of the respective compounds and or enhance the aesthetics of the blends. These additives will not interfere with the performance of the composition, most importantly the scratch and mar performance. Modifiers may include ultraviolet absorbers, hindered amine light stabilizers, secondary phosphites, antioxidants, and internal process aids, such as lubricants. These said materials are trademarked under: Chimassorb™, Tinuvin™, Irganox™, Irgafos,™ P-EPQ™, Ultranox ™, Cyasorb™, and Ultranox™. These materials are trademarked by Ciba Specialty Chemicals, Clariant Corporation, Cytec Industries, and General Electric Specialty Chemicals.

Another portion of the polyolefin blend may come from color concentrates; these would be added between 0 to 10 weight percent.

The polyolefin blend may further incorporate fatty acid type waxes or high molecular siloxanes or siloxane masterbatches to improve upon the scratch and mar resistance and cycling performance of these materials. These ingredients may be trademarked under Erucamide (ER, refined erucamide), Behanamide (BR, refined behanamide), Croda 203 (oleyl palmitamide) by Croda Universal; or trademarked as MB 50-001 (50% active in PP); MB 50-002 (50% active in PE); MB 50-321 (50% active in PP); MB 50-008 (50% active in SAN.); MB 50-011 (50% active in nylon.) by Dow Chemicals.

These blends may include mineral and polymeric fillers to adjust the physical properties of the blend. These may include, but not exclusively limited to talc, calcium carbonate, wollastonite, calcium sulfate, barium sulfate, metal fibers, nanocomposites, ceramic fibers and powders, polymeric fibers, crosslinked polymers, mica, silica, carbon fibers, metal fibers, clay, glass fibers, glass spheres, conductive fillers such as polyaniline, and sulfonated materials such as AMPS.

### EXAMPLES

### Example 1

In one embodiment the blend comprises: a polypropylene containing polymer; a ethylene copolymer of functionalized elastomer, rubber, copolymer or terpolymer; this component may also be partially or completely crosslinked; and a polyolefin-metal salt of an ethylene-based polyolefin-metal salt that is a reaction product of an ethylene acid copolymer with a metal salt ion. This neutralized ethylene-based polyolefin-metal salt must be neutralized at least 5% and should start with an acid content above 5 weight %. The optimal performance is above 60% neutralized with a starting acid content above 6wt %.

The polyolefin blend may contain between 10 to 80 weight percent of propylene polymers, homopolymer or a copolymer of propylene and ethylene (isotactic, atactic, syndiotactic polypropylene); from about 1 to 50 weight percent of a functionalized elastomer, rubber, copolymer or terpolymer, and from about 5 to 60 weight percent of an ethylene-based polyolefin-metal salt that is a reaction product of an ethylene acid copolymer with a metal salt. The percent functionality in the ethylene copolymer should be between 0.5 to 35 weight %.

### Example 2

The prior art described in U.S. Pat. No. 6,403,721 claims several methods for manufacturing a polypropylene modified ionomer blend. They claim the following:

A method for manufacturing propylene-based polyolefin-metal salts includes the steps of contacting a propylene-containing polymer and an organic monomer containing a hydrophilic moiety, and neutralizing the reaction product with metal ions.

A method for manufactuing ethylene-based polyolefin-metal salts includes the steps of contacting a ethylene-containing polymer and an organic monomer containing a hydrophilic moiety, and neutralizing the reaction product with metal ions. With the step of neutralizing the functionalized olefins with the metal ions at approximately the same time as blending with the polyolefin. In this method, it is mentioned that it is preferred to add an already functionalized propylene containing polymer as a separate component.

It also mentions an optional component being added as an interfacial modifier. This is preferably a thermoplastic elastomer, including a styrenic block copolymer. This term references an elastomer having at least one block segment of a styrene repeating unit in combination with saturated and unsaturated rubber monomer segments. It is stated that this typically increases the toughness of the overall blend while maintaining rigidity. Furthermore, it is claimed that this interfacial component is therefore an optional toughener.

It is to be understood that the invention is not to be limited to the exact details of operation, or to the exact compositions, methods, procedures, or embodiments shown and described, as obvious modifications and equivalents will be apparent to one skilled in the art, and the invention is therefore to be limited only by the full scope which can be legally accorded to the appended claims.

References Cited:

U.S. Pat. No. 4,888,391, December, 1989 Domine et al
U.S. Pat. No. 6,207,761, March, 2001 Smith et al
U.S. Pat. No. 6,403,721, June, 2002 Ding et al
U.S. Pat. No. 6,169,145, January, 2001 Medsker et al
   Other Publications

Article entitled “Dynamic Mechanical Properties of Thermoplastic Elastomers from Blends of Polypropylene with Copolymers of Ethylene with Vinyl Acetate” European Polymer Journal, vol. 28, pp. 1451-1458, Jan. 29, 1992

We claim:

1. A polyolefin blend comprising a propylene containing polymer,
an ethylene copolymer elastomer, which is a reaction product of a copolymer of ethylene and at least one alpha-olefin, this elastomer functionalized with maleic anhydride,
wherein the alpha-olefin is selected from 1-octene, 1-hexene, 1-heptene, 1-butene, 4-methyl-1-pentene, and mixtures thereof, and
an ethylene-based polyolefin-metal salt which is the product of an ethylene acid copolymer and a metal salt, the polyolefin-metal salt being an ionomer, an alpha, beta ethylenically unsaturated carboxylic acid polymer in which the acid units are neutralized with metal ion (s).

2. The polyolefin blend of claim 1, wherein the propylene polymer may be at least one of a homopolymer propylene or a random or block copolymer of propylene and ethylene, and the polyolefin blend may be from about 10 to 80 weight percent of the propylene polymer, from about 1 to 50 weight percent of the ethylene copolymer, and from about 5 to 60 weight percent of the polyolefin-metal salt.

3. The polyolefin blend of claim 1, wherein the propylene polymer, for optimal hardness and scratch resistance, consists essentially of from 40 to 75 weight percent of the propylene polymer; from about 1 to 25 weight percent of the ethylene copolymer; and from 5 to 35 weight percent of the polyolefin-metal salt of the blend.

4. The polyolefin blend of claim 1, wherein the ethylene copolymer is crosslinked with peroxide or silane with a catalyst selected from the transition metals of Group VIII, including complexes of these metals, this material optionally crosslinked prior to compounding or in situ.

5. The polyolefin blend of claim 1, wherein the ethylene copolymer is a crosslinked/partially vulcanized thermoplastic elastomer.

6. The polyolefin blend of claim 1, wherein the propylene polymer is selected from at least one of a homopolymer propylene, a random or block copolymer of propylene, and ethylene, and the polyolefin blend may be from about 5 to 75 weight percent of the propylene polymer, from about 1 to 50 weight percent of the ethylene copolymer, and from about 5 to 65 weight percent of the polyolefin-metal salt.

7. The polyolefin blend of claim 1, which includes an interfacial impact modifier selected from a styrene-ethylene interpolymer, styrenic block copolymer or elastomer, and a random styrenic copolymer or elastomer, all of which may have been modified with maleic anhydride.

8. The polyolefin blend of claim 1, wherein the styrenic copolymers, interpolymers or elastomers modified with maleic anhydride represent between 1 to about 30 weight percent of the blend.

9. The polyolefin blend of claim 1, further comprising an ethylene vinyl acetate (EVA) with a vinyl acetate level between 5 to 80 weight percent with maleic anhydride or hydroxy ethyl acrylate.

10. The polyolefin blend of claim 1, wherein the functionalized ethylene vinyl acetate represents between 1 to 30 weight percent of the blend.

11. The polyolefin blend of claim 1, further comprising one or more of terpolymers or copolymers of ethylene, butyl acrylate, and glycidyl methacrylate (GMA); terpolymers of ethylene, ethyl, methyl or butyl acrylate, and maleic anhydride (MAH); terpolymers of ethylene, acrylic ester and maleic anhyrdride.

12. The polyolefin blend of claim 1, wherein the MAH (unsaturated anhydride) and acrylate (GMA) may be physically crosslinked prior to addition to blend or in situ.

13. The polyolefin blend of claim 1, wherein the modified acrylate copolymers or terpolymers may react with the free acid of the ionomer component.

14. The polyolefin blend of claim 1, wherein the modified acrylate copolymer or terpolymers represent between 1 to 30 weight percent.

15. The polyolefin blend of claim 1, wherein the polyolefin-metal salt is a copolymer or terpolymer ionomer, which is partially neutralized with a metal salt from 5 to 95%.

16. The polyolefin blend of claim 1, wherein the terpolymer ionomer is modified with methyl, butyl, or ethyl acrylate; wherein the acrylate content from 1 to 25 weight percent.

17. The polylefin blend of claim 16, wherein the acrylate content represents between 10 and 25 weight percent.

18. The polyolefin blend of claim 1, wherein the metal ion is selected from the group consisting of lithium, sodium, potassium, magnesium, calcium, barium, lead, tin, zinc, aluminum, cadmium, and mixtures thereof.

19. the polyolefin blend of claim 1, wherein the ethylene copolymer may include a low molecular weight ionomer wax or functionalized monomer representing from about 1 to 20 weight percent.

20. The polyolefin blend of claim 1, further comprising a filler from about 1 to 40 weight percent.

21. The polyolefin blend of claim 1, wherein the mineral filler is selected from talc, calcium carbonate, wollastonite, calcium sulfate, barium sulfate, metal fibers, nanocomposites, ceramic fibers and powders, polymeric fibers, crosslinked polymers, mica, silica, carbon fibers, metal fibers, clay, glass fibers, glass spheres, conductive fillers such as polyaniline, and sulfonated materials such as AMPS.

22. The polyolefin blend of claim 1, further comprising a surface and mold release agent such as high molecular weight silicone and silicone masterbatches, fatty acids (i.e. olyel palmitamide, erucamide and behanamide) representing from about 0.1 to 10 weight percent.

23. A process for preparing an article from a polyolefin blend consisting essentially of:
providing a propylene polymer containing polymer,
adding a compound which may act as an impact modifier or interfacial agent selected from at least one of: ionomer waxes or functionalized monomers; impact modifiers and functionalized modifiers; a styrenic copolymer or elastomer with maleic anhydride grafting; ethylene vinyl acetate modified with maleic anhydride or hydroxyl ethyl acrylate; terpolymers or copolymers selected from one or more of ethylene, butyl acrylate, and glycidyl methacrylate; terpolymers of ethylene, ethyl, methyl or butyl acrylate, and maleic anhydride; ethylene-propylene rubber with maleic anhydride grafting, the ionomer portion may be a copolymer or terpolymer modified with acrylate;
adding an ethylene based polyolefin-metal salt that is a reaction product of an ethylene containing polymer and a second organic monomer containing a hydrophilic moiety; such component being at least partially neutralized with a metal salt between 5 to 95%;
mixing the ethylene copolymer until partially or completely crosslinked and adding to the blend; or
crosslinking in situ while adding the propylene polymer and polyolefin-metal salt; or
mixing the propylene polymer, ethylene copolymer, and polyolefin-metal salt; and
injection molding, blow molding or extruding the blend into an article which will display high scratch resistance, low blushing upon impact, low temperature requirements when mandated, tape adhesion, molded in color, controlled gloss levels, superior weatherability, and sonic welding capabilities.
